(19) United States
(12) Patent Application Publication
(10) Pub. No.: US 2022/0164630 A1
(43) Pub. Date: May 26, 2022

(54) 3D SEPARABLE DEEP CONVOLUTIONAL NEURAL NETWORK FOR MOVING OBJECT DETECTION

(71) Applicants: KWAI INC., Palo Alto, CA (US); SANTA CLARA UNIVERSITY, Santa Clara, CA (US)

(72) Inventors: Bingxin HOU, Santa Clara, CA (US); Ying LIU, Santa Clara, CA (US); Nam LING, Santa Clara, CA (US); Lingzhi LIU, San Jose, CA (US); Yongxiong REN, San Jose, CA (US); Ming Kai HSU, Fremont, CA (US)

(73) Assignees: KWAI INC., Palo Alto, CA (US); SANTA CLARA UNIVERSITY, Santa Clara, CA (US)

(21) Appl. No.: 17/533,012

(22) Filed: Nov. 22, 2021

Related U.S. Application Data
(60) Provisional application No. 63/116,689, filed on Nov. 20, 2020.

(51) Int. Cl. G06N 3/04; G06K 9/00; G06T 7/20

(52) U.S. Cl. CPC G06N 3/04; G06T 7/20; G06K 9/00711

(57) ABSTRACT

A method for detecting moving objects in video frames, an apparatus and a non-transitory computer-readable storage medium thereof are provided. The method includes that: an encoder in a 3-dimenional (3D) separable convolutional neural network with multi-input multi-output (3DS_MM) receives a first input including multiple video frames, where the encoder includes a plurality of encoder layers including 3D separable convolutional neural network (CNN) layers; the encoder generates a first encoder output; and a decoder in the 3DS_MM receives the first encoder output and generates a first output including multiple first binary masks related to the first input, where the decoder includes a plurality of decoder layers comprising 3D separable transposed CNN layers.

### CROSS-REFERENCE TO RELATED APPLICATION

The present application claims priority to U.S. Provisional Application No. 63/116,689, entitled “3D SEPARABLE DEEP CONVOLUTIONAL NEURAL NETWORK FOR MOVING OBJECT DETECTION,” filed on Nov. 20, 2020, the entirety of which is incorporated by reference for all purposes.

### FIELD

The present application generally relates to convolutional neural network, and in particular but not limited to, 3D separable deep convolutional neural network for moving object detection.

### BACKGROUND

With the increasing amount of network cameras, produced visual data and Internet users, it becomes quite challenging and crucial to process a large amount of video data at a fast speed. Moving object detection (MOD) is the process of extracting dynamic foreground content from the video frames, such as the moving vehicles or pedestrians, while discarding the non-moving background. It plays an essential role in many computer vision areas or applications, such as intelligent video surveillance, medical diagnostics, anomaly detection, traffic monitoring, and human tracking and action recognition.

Conventional approaches for moving object detection have been extensively studied and improved over the years. They are unsupervised which do not require labeled ground truth for algorithm development. They may include two steps: background modeling and pixel classification. However, it's quite difficult for conventional approaches to perform robust object detection in complex scenarios, such as videos with illumination changes, shadow, night scenes, and dynamic background.

With the availability of huge amount of data and the development of powerful computational infrastructure, deep neural networks (DNNs) have shown remarkable improvements in MOD problems and are developed to replace either the background modeling or the pixel classification in conventional methods or to combine these two steps into an end-to-end network. Existing DNN models are mostly supervised approaches based on 2-dimensional (2D) convolutional neural networks (CNNs), 3D CNNs, 2D separable CNNs, ro generative adversarial networks (GANs). The 2D CNN adopts 2D convolution operation to extract spatial low-, mid-, and high-level features, which turns out to be very helpful in computer vision problems. Recently, 3-dimensional convolutional neural network (3D CNN) is also proposed to learn the spatial and temporal features simultaneously, which are more suitable and effective in video related tasks. Besides, unsupervised GANs and semi-supervised networks are also proposed. It demonstrates that the DNNs can automatically extract spatial low-, mid-, and high-level features as well as temporal features, which turn out to be very helpful in MOD problems.

However, while existing DNN models offer superior moving object, they generally have some common issues: computation-expensive and memory-intensive. In particular, compared to 2D CNN, the architecture change in 3D CNN leads to a huge increase in the model size and computational complexity, making it challenging to apply those models to real-world scenarios, such as robotics, self-driving cars, and augmented reality. The enormous model size of deep neural networks makes it challenging to deploy those models in mobile and embedded devices, which have limited memory and computing resources. Besides, these tasks are delay-sensitive and need to be carried out in a timely manner, which cannot be achieved by high-complexity deep learning models. Thus, model optimization and acceleration are very critical and practical. A deep moving object detection model suitable for mobile and embedded environment that can achieve faster inference speed and smaller model size while maintaining high detection accuracy is desirable.

### SUMMARY

The present disclosure describes examples of techniques relating to detecting moving objects in video frames using 3D separable CNN with multi-frame input multi-frame output, i.e. multi-input multi-output (MIMO).

According to a first aspect of the present disclosure, a method for detecting moving objects in video frames is provided. The method includes that an encoder in a 3D separable CNN with MIMO (3DS_MM) receives a first input including multiple video frames, where the encoder includes a plurality of encoder layers including 3D separable CNN layers; the encoder generates a first encoder output; and a decoder in the 3DS_MM receives the first encoder output and the decoder generates a first output including multiple first binary masks related to the first input, where the decoder includes a plurality of decoder layers including 3D separable transposed CNN layers.

According to a second aspect of the present disclosure, an apparatus for detecting moving objects in video frames is provided. The apparatus includes one or more processors; and a memory configured to store instructions executable by the one or more processors.

Further, the one or more processors, upon execution of the instructions, are configured to: receive a first input including multiple video frames by an encoder in a 3DS_MM, where the encoder includes a plurality of encoder layers including 3D separable CNN layers; generate a first encoder output by the encoder; and receive the first encoder output by a decoder in the 3DS_MM and generate a first output including multiple first binary masks related to the first input by the decoder, where the decoder includes a plurality of decoder layers including 3D separable transposed CNN layers.

According to a third aspect of the present disclosure, a non-transitory computer-readable storage medium for detecting moving objects in video frames storing computer-executable instructions is provided. Upon execution of the instructions by one or more processors, the instructions cause the one or more processors to perform acts including: receiving, by an encoder in a 3DS_MM, a first input including multiple video frames, where the encoder includes a plurality of encoder layers including 3D separable CNN layers; generating, by the encoder, a first encoder output; and receiving, by a decoder in the 3DS_MM, the first encoder output and generating, by the decoder, a first output including multiple first binary masks related to the first input, wherein the decoder includes a plurality of decoder layers including 3D separable transposed CNN layers.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1A is a block diagram illustrating 2D convolution with 3D input in accordance with an example of the present disclosure.

FIG. 1B is a block diagram illustrating 3D convolution with 4D input in accordance with an example of the present disclosure

FIG. 2A is a block diagram illustrating standard 3D convolution in accordance with an example of the present disclosure.

FIG. 2B is a block diagram illustrating depth-wise convolution in 3D separable convolution in accordance with an example of the present disclosure.

FIG. 2C is a block diagram illustrating point-wise convolution in 3D separable convolution in accordance with an example of the present disclosure.

FIG. 3 is a block diagram illustrating the 3DS_MM in accordance with an example of the present disclosure.

FIG. 4A illustrates an encoder block in the 3DS_MM in accordance with an example of the present disclosure.

FIG. 4B illustrates a decoder block in the 3DS_MM in accordance with an example of the present disclosure.

FIG. 5A illustrates difference between Single Input Single Output (SISO), Multi input Single Output (MISO), and MIMO in accordance with an example of the present disclosure.

FIG. 5B illustrates a MIMO strategy used in an inference process in accordance with an example of the present disclosure.

FIG. 6A illustrates detection accuracy metrics in F-measure versus inference speed on an NVIDIA Titan GPU of the 3DS_MM model and other models in three experiments including scene dependent evaluation (SDE) setup, category-wise scene independent evaluation (SIE) setup, and complete-wise SIE setup in accordance with an example of the present disclosure.

FIG. 6B illustrates detection accuracy metrics in S-measure versus inference speed on an NVIDIA Titan GPU of the 3DS_MM model and other models in three experiments including SDE setup, category-wise SIE setup, and complete-wise SIE setup in accordance with an example of the present disclosure.

FIG. 6C illustrates detection accuracy metrics in E-measure versus inference speed on an NVIDIA Titan GPU of the 3DS_MM model and other models in three experiments including SDE setup, category-wise SIE setup, and complete-wise SIE setup in accordance with an example of the present disclosure.

FIG. 6D illustrates detection accuracy metrics in MAE versus inference speed on an NVIDIA Titan GPU of the 3DS_MM model and other models in three experiments including SDE setup, category-wise SIE setup, and complete-wise SIE setup in accordance with an example of the present disclosure.

FIG. 7 illustrates visual comparison of sample results from CDnet2014 dataset in video-optimized SDE setup in accordance with an example of the present disclosure.

FIG. 8 illustrates visual comparison of unseen sample results from CDnet2014 dataset in category-wise SIE setup in accordance with an example of the present disclosure.

FIG. 9 illustrates visual comparison of unseen sample results from DAVIS2016 dataset in complete-wise SIE setup in accordance with an example of the present disclosure.

FIG. 10 is a block diagram illustrating an apparatus for detecting moving objects in video frames in accordance with an example of the present disclosure.

FIG. 11 is a flowchart illustrating a method for detecting moving objects in video frames using the 3DS_MM in accordance with an example of the present disclosure.

FIG. 12 illustrates accuracy comparison of various methods in SDE setup in each video category in accordance with an example of the present disclosure.

FIG. 13 illustrates comparative F-measure, S-measure, E-measure, and MAE performance in category-wise SIE setup for unseen videos on CDnet2014 dataset in accordance with an example of the present disclosure.

FIG. 14 illustrates comparative F-measure, S-measure, E-measure, and MAE performance in complete-wise SIE setup for unseen videos on DAVIS2016 dataset in accordance with an example of the present disclosure.

FIG. 15 illustrates the overall performance including inference speed, trainable parameters, computational complexity, model size, and detection accuracy of the 3DS_MM and other methods in accordance with an example of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g. devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may include steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

The present disclosure a lightweight and flexible model for moving object detection, which is an efficient 3D separable convolutional neural network with a multi-input multi-output called “3DS_MM”. This model is tailored for computation-resource-limited and delay-sensitive applications. This model significantly increases inference speed and reduces model size, meanwhile increasing detection accuracy or maintaining a competitive detection accuracy by utilizing the temporal information in the video data and increases the inference speed by adopting a multi-frame input to multi-frame output strategy, while reducing the computational complexity and model size by simplifying the standard 3D convolution with separable convolutions.

The present disclosure also provides a 3D separable CNN for moving object detection. The network adopts 3D convolution to explore the spatio-temporal information in the video data and to improve the detection accuracy. To reduce the computational complexity and model size, the 3D convolution operation is decomposed into a depth-wise convolution and a point-wise convolution. While existing 3D separable CNN schemes all addressed other problems such as gesture recognition, force prediction, 3D object classification or reconstruction, the present disclosure applies 3D separable CNN schemes to the moving object detection task for the first time.

The present disclosure provides a MIMO strategy in the 3D separable CNN. While existing networks are SISO, MISO, or two-input two-output, the MIMO network provided in the present disclosure can take multiple input frames and output multiple binary masks using temporal-dimension in each sample. This MIMO embedded in 3D separable CNN can further increase model inference speed significantly and maintain high detection accuracy. The present disclosure is the first to use MIMO scheme in the MOD task. In the present disclosure, the multi-frame output scheme is used in the decoder network for prediction efficiency.

By running experiments on publicly available datasets, the present disclosure demonstrates that the proposed 3DS_MM offers superior performance in terms of the detection accuracy in F-measure, inference speed in frames per second (fps), model size in megabytes (MB), and computational complexity in floating-point operations (FLOPs) compared to standard 2D CNN, 2D separable CNN, standard 3D CNN and other state-of-the-art deep models in moving object detection. In some examples, the 3DS_MM offers overwhelmingly high inference speed in frames per second (154 fps) and extremely small model size (1:45 MB), while achieving the best detection accuracy in terms of F-measure, S-measure, E-measure, and MAE among all models in SDE setup and achieving the best detection accuracy among the models with inference speeds exceeding 65 fps in SIE setup. The SDE setup is widely used to tune and test the model on a specific video as the training and test sets are from the same video. The SIE setup is specifically designed to assess the generalization capability of the model on completely unseen videos.

### Algorithms for Moving Object Detection

The methods for MOD problems can be broadly categorized into: (1) traditional methods (unsupervised learning), and (2) deep learning methods (supervised and semi-supervised learning).

Unsupervised methods basically consist of two components: (1) background modeling and maintenance which initialize the background scene and update it over time, and (2) pixel classification which classifies each pixel to be foreground or background. There are many background modeling schemes, such as the temporal or adaptive filters being applied to build the background like running average background, temporal median filtering, and Kalman filtering. Another way for background modeling is to statistically represent the background using parametric probability density functions such as a single Gaussian or a mixture of Gaussians. On the other hand, non-parametric methods directly rely on observed data to model the background such as IUTIS-5, WeSamBE, SemanticBGS, and kernel density estimation. Sample consensus is another non-parametric strategy used in PAWCS, ViBe and SuBSENSE. In particular, SuB SENSE uses a feedback system to automatically adjust the background model based on the local binary similarity pattern (LBSP) features and pixel intensities. Eigen-background based on principal-component analysis (PCA) is also used in background modeling. Further, background subtraction based on robust principal-component analysis (RPCA) solves camera motion and reduces the curse of dimensionality and scale. For example, the model in the running average background dynamically updates the background image to adapt to the scene changes by computing the weighted sum of the current frame and the previously estimated background image. Other examples are IUTIS-5 and SuB SENSE that use a feedback system to automatically adjust the background model based on the local binary similarity pattern (LBSP) features and pixel intensities. Whether a pixel is classified to be foreground or background depends on whether the predicted probability of that pixel being the foreground exceeds a given threshold.

Deep learning-based methods are mostly supervised and have been recently proposed for MOD problems. Deep learning-based methods skip the background estimation component with a well-defined network structure that can compensate for the contribution from backgrounds. Examples include the Cascade scheme, which proposed a patch-wise method with a cascade CNN architecture. Although it achieved good detection performance, the patch-wise processing is very time consuming. Another example is the VGG-16 based network called FgSegNet_S. FgSegNet_S is a 2D CNN that takes each video frame at its original resolution scale as the input, while in its extension version FgSegNet_M, the network takes each video frame at three different resolution scales in parallel as the input of the encoding network. Both FgSegNet_S and FgSegNet_M adopt the transposed convolutional layers in the decoding network to output the binary masks.

Some deep learning methods replace the pixel classification component with a well-defined network structure. In the first CNN based moving object detection scheme ConvNets, the background is estimated by a temporal median filter, then the estimated backgrounds are stacked with the original video frames to form the input of the CNN that outputs the binary masks of detected objects. For each pixel in a video sequence, the image patch centered on that pixel is extracted and stacked with the corresponding patch from the background image to form the input of the network. Such a pixel-wise processing scheme has high computational complexity. DeepBS utilizes SuBSENSE algorithm to generate background image and multiple layers CNN for segmentation. Also, a spatial-median filter is used for post-processing to perform smoothing. Additionally, a multi-scale patch-wise method with a cascade CNN architecture called MSCNNCCascade is proposed. Although it achieves good detection performance, the patch-wise processing is very time consuming.

Other multi-scale feature learning-based models such as Guided Multi-scale CNN, MCSCNN, MsEDNet and VGG-16 based networks FgSegNet_M and FgSegNet_v2 were also proposed. FgSegNet_S is a 2D CNN that takes each video frame at its original resolution scale as the input, while its extended version FgSegNet_M takes each video frame at three different resolution scales in parallel as the input of the encoding network. FgSegNet_v2 is the best-performing FgSegNet model in CDnet2014 challenge. Another example, MSFgNet, has a motion-saliency network (MSNet) that estimates the background and subtracts it from the original frames, followed by a foreground extraction network (FgNet) that detects the moving objects.

3D convolution is applied to MOD problems to utilize spatial-temporal information in visual data. 3D CNN and a fully connected layer can be adopted in a patch-wise method. 3D-CNN-BGS uses 3D convolution to track temporal changes in video sequences. This approach performs the 3D convolution on 10 consecutive frames of the video, and upsamples the low-, mid-, and high-level feature layers of the network in a multi-scale approach to enhance segmentation accuracy. 3D CNN and a fully connected layer were used in a patch-wise method. Both of these two methods offer accurate detection results with high computational complexity. 3DAtrous captures long-term temporal information in the video data. It is trained based on a long short-term memory (LSTM) network with focal loss to tackle the class imbalance problem commonly seen in background subtraction. Another LSTM-based example is the autoencoder-based 3D CNNLSTM combining 3D CNNs and the long short-term memory (LSTM) networks. The time-varying video sequences are handled by 3D convolution to capture the short temporal motions, while the long short-term temporal motions are captured by 2D LSTMs. As 3D CNN is more powerful for learning spatio-temporal features, it is also applied to many other areas such as video super-resolution, audio-visual recognition, and human action recognition.

Furthermore, generative adversarial networks (GAN) is adopted in MOD problems, such as BScGAN, BSGAN, BSPVGAN, FgGAN, BSlsGAN, and RMS-GAN. BScGAN is based on conditional generative adversarial network (cGAN) that consists of two networks: generator and discriminator. BSGAN [59] and BSPVGAN are based on Bayesian GANs. They use median filter for background modeling and Bayesian GANs for pixel classification. The use of Bayesian GANs can address the issues of sudden and slow illumination changes, non-stationary background, and ghost. In addition, BSPVGAN exploits parallel vision to improve results in complex scenes. Adversarial learning can be used to generate dynamic background information in an unsupervised manner.

However, the performance of all the aforementioned deep learning-based moving object detection methods comes at a high computational cost and a slow inference speed due to complex network structures and intense convolution operations. To reduce the amount of calculation, the MobileNet is proposed to separate the standard 2D convolution into a depth-wise convolution and a point-wise convolution. A 2D separable CNN for moving object detection was also proposed in the present disclosure. It dramatically increases the inference speed and maintains a high detection accuracy. It dramatically increases the inference speed and maintains high detection accuracy. However, these 2D separable CNN-based networks do not exploit the temporal information in the video input.

In the present disclosure, the 2D separable CNN is extended to a 3D separable CNN, which reduces the computational complexity compared to standard 3D CNN. The 3D separable CNN was developed to utilize the spatial-temporal information in visual data, while simplifying the 3D convolution operations. It has been successfully applied to several computer vision areas such as the dynamic hand gesture recognition, brain tumor segmentation, and 3D reconstruction tasks.

Although some existing models adopt 3D separable CNN to extract high-dimensional features, none of them applied it to the problem of moving object detection. For example, a 3D separable CNN may be used for hand-gesture recognition, in which the last two layers of the network are fully connected layers that output class labels. Another 3D separable CNN may be used for two tasks: 3D object classification and reconstruction. Neither task utilizes temporal data, hence no temporal convolution is involved. A 3D separable CNN may be used to predict interactive force between two objects; hence its network output is a scalar representing the predicted force value. This problem essentially is a regression problem. Besides, the way that the 3D convolution is separated may be different. Channel-wise 2D convolution for each independent frame and Channel may be first conducted, then joint temporal-channel-wise convolution is conducted. In contrast, in the present disclosure, 3D separable CNN performs spatial-temporal convolution first, then performs pointwise convolution along the channel direction.

Another factor that limits the inference speed is the input-output relationship. The input-output relationship of existing moving object detection networks has two types: (1) SISO, which is widely exploited in 2D CNNs such as FgSegNet_S and 2D separable CNN; and (2) MISO which can be found in 3D CNNs such as 3D-CNN-BGS, 3DAtrous, and DMFC3D. The disadvantage of SISO and MISO is that they result in a slow inference speed because only one frame output is predicted in every forward pass. For example, X-Net adopts a two-input two-output network structure, which takes two adjacent video frames as the network input and generates the corresponding two binary masks. Although it can track temporal changes, the network structure is inflexible and the temporal correlation it utilizes is limited. The present disclosure provides a MIMO strategy, which can take multiple input frames and output multiple frames of binary masks in each sample. It explores temporal correlations on a larger time span and significantly increases the inference speed when embedded in 3D separable CNN.

Another issue for supervised methods is the generalization capability of the trained models on completely unseen videos. Several moving object detection models were designed and evaluated over completely unseen videos, such as BMN-BSN, BSUV-Net, BSUV-Net 2.0, BSUV-NetCSemBGS, ChangeDet, and 3DCD. Besides, semi-supervised networks were also designed to be extended to unseen videos. For example, GraphBGS and GraphBGS-TV are based on the reconstruction of graph signals and semi-supervised learning algorithm, MSK is based on a combination of offline and online learning strategies, and HEGNet combines propagation-based and matching-based methods for semi-supervised video moving object detection.

The present disclosure provides a lightweight 3D separable CNN specifically for moving object detection in computation-resource-limited and delay-sensitive scenarios. It has an efficient encoder-decoder structure embedding a MIMO strategy named as the “3DS_MM”. The proposed network does not require explicit background modeling and maintenance. It significantly increases the inference speed, reduces the computational complexity and model size, meanwhile achieving the highest detection accuracy in SDE setup and maintaining a competitive detection accuracy in SIE setup.

In some examples, the proposed network model is evaluated over CDnet2014 dataset in an SDE framework with other state-of-the-art models, and the generalization capability of the model is assessed over CDnet2014 and DAVIS2016 datasets in SIE setups over completely unseen videos.

Here, the rationale of the 3D separable convolution operation is elaborated, which is the building block of the proposed 3DS_MM. As an example, the default data format “NLHWC” in Tensorflow is used to represent data, which denotes the batch size N, the temporal length L, the height of the image H, the width of the image W, and the number of channels C.

### 2D Convolution Vs. 3D Convolution

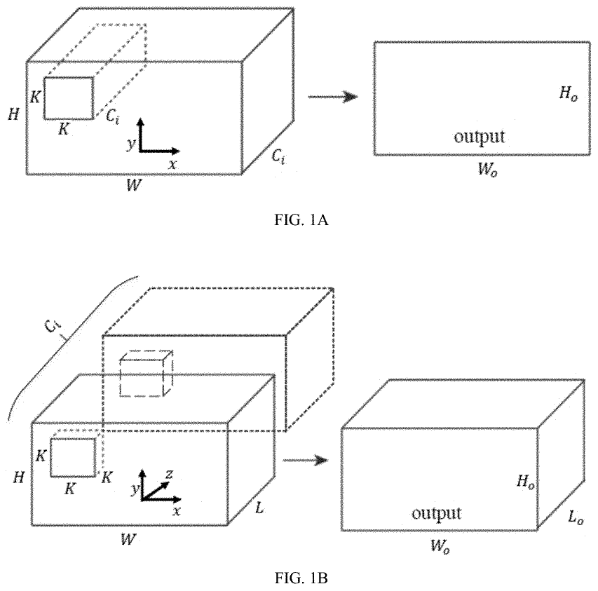

FIG. 1A is a block diagram illustrating 2D convolution with 3D input in accordance with an example of the present disclosure. As shown in FIG. 1A, an ordinary 2D convolution takes a 3D tensor of size H×W×Cᵢ as the input, where H and W are the height and width of feature maps, and Cᵢ is the number of input channels. In this case, the filter is a 3D filter in a shape of K×K×Cᵢ moving in 2 directions (y, x) to calculate a 2D convolution. The output is a 2D matrix of size H₀×W₀. If the filter number is C₀, the output shape will be H₀×W₀×C₀. The mathematical expression of such 2D convolution is given by

$$Out [ h , w ] = {\sum }_{j = 0}^{K - 1} {\sum }_{i = 0}^{K - 1} {\sum }_{c = 0}^{{C}_{i} - 1} f [ j , i , c ] \times In [ h - j , w - i , c ) \qquad ( 1 )$$

where In represents the 3D input to be convolved with the 3D filter f to result in a 2D output feature map Out. Here, h, w and c are the height, width, and channel coordinates of the 3D input, while j, i and c are those of the 3D filter.

However, for video signals the 2D convolution in FIG. 1A does not leverage the temporal information among adjacent frames. 3D convolution addresses this issue using 4D convolutional filters with 3D convolution operations, as illustrated in FIG. 1B. In a 3D convolution, the “input” becomes Cᵢ channels of 3D tensors of size L×H×W, where L is the temporal length, i.e. the number of successive video frames. Hence, the input is 4D and is of size L×H×W×Cᵢ. A 4D convolutional filter of size K×K×K×Cᵢ moves in 3 directions (z, y, x) to calculate convolutions, where z, y, and x align with the temporal length, height, and width axes of the 4D input. The output shape is L₀×H₀×W₀. If the filter number is Cₒ, the output shape will be L₀×H₀×W₀×C₀. The mathematical expression of the 3D convolution with a 4D input is given by

$$Out [ l , h , w ] = \begin{matrix}{\sum }_{k = 0}^{K - 1} {\sum }_{j = 0}^{K - 1} {\sum }_{i = 0}^{K - 1} {\sum }_{c = 0}^{{C}_{i} - 1} \\ f [ k , j , i , c ] \times In [ l - k , h - j , w - i , c ]\end{matrix} \qquad ( 2 )$$

where In represents the 4D input to be convolved with the 4D filter f to result in a 3D output Out. Here, l, h, w, and c are the temporal length, height, width, and channel coordinates of the 4D input, while k, j, i and c are those of the 4D filter. If the size of the filter is K×K×K×Cᵢ, then the indices k, j, i range from 0 to K−1, and c ranges from 0 to Cᵢ−1.

The ability to leverage the temporal context can improve the moving object detection accuracy. However, the 3D CNN is rarely used in practice because it suffers from a high computational cost due to the increased amount of computation used by 3D convolutions, especially when the dataset scale goes larger and the neural network model goes deeper. Thus, in order to make use of the temporal features, a low-complexity 3D CNN must be developed.

### 3D Convolution Vs. 3D Separable Convolution

2D separable convolution splits traditional 2D convolution into a depth-wise convolution and a point-wise convolution, which drastically reduces computational complexity. In order to utilize temporal features in video data, the idea of separable convolution can be applied to the standard 3D convolution.

The standard 2D convolutional layer is parameterized by a convolution filter of size K×K×Cᵢ, where K×K is the spatial dimension of the filter and C₁ is the number of input channels. The computational complexity of the standard 2D convolution measured by the number of floating-point multiplications is

K×K×Cᵢ×Hₒ×Wₒ×Cₒ. (3)

While such convolution effectively extracts features using the 3D filter, it also requires intensive computation. The separable 2D convolution, on the other hand, splits this into a depth-wise convolution and a point-wise convolution, which drastically reduces the computation and model size.

The depth-wise convolution performs an independent convolution on each input channel with a filter of size K×K×1, without interactions among channels. The required multiplications of the 2D depth-wise convolution is

K×K×1×Hₒ×Wₒ×Cᵢ (4)

Following the depth-wise convolution is the point-wise convolution. It performs a 1D convolution on each depth column that is formed by voxels at the same spatial location (y, x) across all channels, using a filter of size 1×1×Cᵢ. This creates a linear projection of the stack of feature maps. If Co filters are used, then the required multiplications of this 1D point-wise convolution is

1×1×Cᵢ×Hₒ×Wₒ×Cₒ. (5)

By decomposing the standard 2D convolution into two separate steps, achieved is a computation reduction of

$$\begin{matrix}ratio = \frac{2 D separable convolution}{2 D convolution} \\ = \frac{K \times K \times {H}_{o} \times {W}_{o} \times {C}_{i} + {C}_{i} \times {H}_{o} \times {W}_{o} \times {C}_{o}}{K \times K \times {C}_{i} \times {H}_{o} \times {W}_{o} \times {C}_{o}} \\ = \frac{1}{{C}_{o}} + \frac{1}{{K}^{2} .}\end{matrix} \qquad ( 6 )$$

When the output channels Cₒ is a large number, the first term

$$\frac{1}{{C}_{0}}$$

is negligible. For instance, if K=3, then the 2D separable convolution can achieve roughly 9 times less computation than the standard 2D convolution.

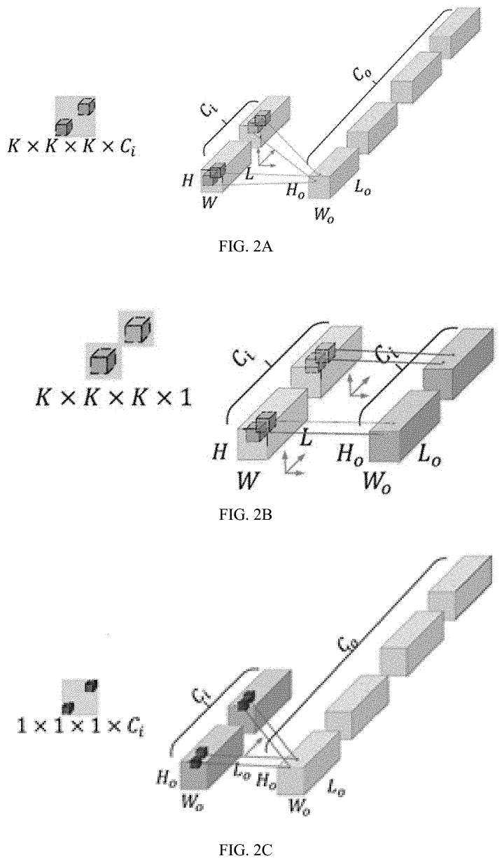

In order to utilize the temporal features in the video data, the idea of separable convolution can be applied to the standard 3D convolution. FIG. 2A is a block diagram illustrating standard 3D convolution in accordance with an example of the present disclosure. Arrows in FIG. 2A point to effective directions of the convolution calculation of the 3D filters. As shown in FIG. 2A, in the standard 3D convolution, the 4D input of size L×H×W×Cᵢ, is convolved with Cₒ filters of size K×K×K×Cᵢ, resulting in a 4D output of size L₀×H₀×W₀×C₀. The computational complexity of such standard 3D convolution is

K×K×K×Cᵢ×Lₒ×Hₒ×Wₒ×Cₒ. (7)

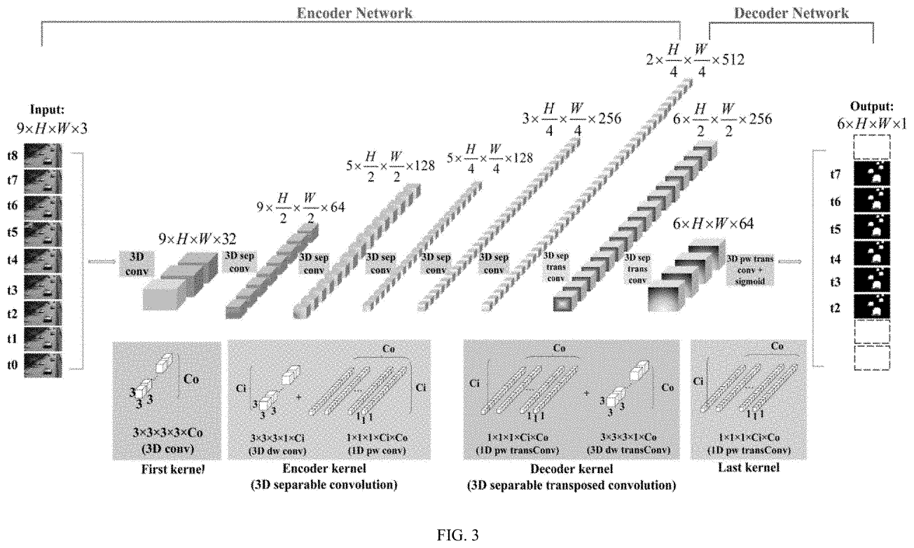

To simplify the 3D convolution, it is decomposed into a 3D depth-wise convolution and a 1D point-wise convolution. As shown in FIG. 3B, in the first step, the 3D depth-wise convolution adopts Cᵢ independent filters of size K×K×K×1 to perform a 3D convolution on each input channel. This procedure is described in (8). The required multiplications of such 3D depth-wise convolution is K×K×K×1×L₀×H₀×W₀×Cᵢ.

$$Out [ l , h , w , c ] = {\sum }_{k = 0}^{K - 1} {\sum }_{j = 0}^{K - 1} {\sum }_{i = 0}^{K - 1} f [ k , j , i , c ] \times In [ l - k , h - j , w - i , c ] , c = 1 , 2 … {C}_{i} . \qquad ( 8 )$$

Afterwards, the output of FIG. 2B is used as the input of FIG. 2C. As shown in FIG. 2C, in the second step, the point-wise convolution adopts Cₒ filters of size 1×1×1×Cᵢ, performs a linear projection along the channel axis as shown by the arrow, and outputs a 3D tensor of size L₀×H₀×W₀. This procedure is described in (9). Using Cₒ such filters outputs Cₒ 3D tensors. The required multiplications of such 1D point-wise convolution is 1×1×1×Cᵢ×L₀×H₀×W₀×C₀.

$$Out [ l , h , w ] = {\sum }_{s = 0}^{{C}_{i} - 1} f [ s ] \times In [ l , h , w , c - s ] . \qquad ( 9 )$$

The combination of the 3D depth-wise convolution and the 1D point-wise convolution, called 3D separable convolution, achieves a reduction in computational complexity of

$$\begin{matrix}ratio = \frac{3 D separable convolution}{3 D convolution} \\ = \frac{K \times K \times K \times {L}_{o} \times {H}_{o} \times {C}_{i} + {C}_{i} \times {L}_{0} \times {H}_{o} \times {W}_{o} \times {C}_{o}}{K \times K \times K \times {C}_{i} \times {L}_{o} \times {H}_{o} \times {W}_{o} \times {C}_{o}} \\ = \frac{1}{{C}_{o}} + \frac{1}{{K}^{3} .}\end{matrix} \qquad ( 10 )$$

With K=3 and a large Cₒ, the computational complexity can be reduced by roughly 27 times compared to the standard 3D convolution.

It is observed that such a factorized 3D convolution can substantially reduce the amount of computation, meanwhile extracting temporal features in the video sequence. This disclosure adopts such 3D separable convolution in a moving object detection network.

The deep moving object detection network provided in the present disclosure is based on two major designs: (1) the encoder-decoder based 3D separable CNN and (2) the MIMO strategy.

Encoder-decoder based 3D Separable CNN

As shown in FIG. 3, the proposed network is an encoder-decoder based CNN utilizing the 3D separable convolution. The network involves 6 blocks in the encoder network and 3 blocks in the decoder network. These block numbers are selected to provide a good trade-off between the inference speed and the detection accuracy. The network shown in FIG. 3 is only an example. The number of blocks in the encoder network and the decoder network may not limited to the number as illustrated in FIG. 3. Table 1 shows the details of the network and the shape of the input and output in each layer.

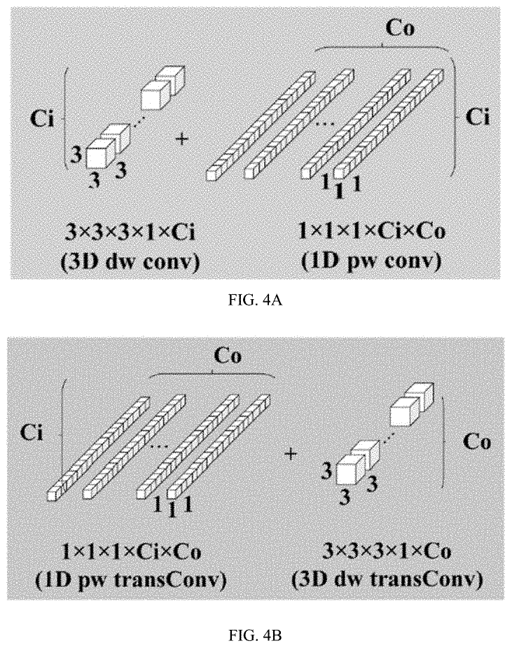

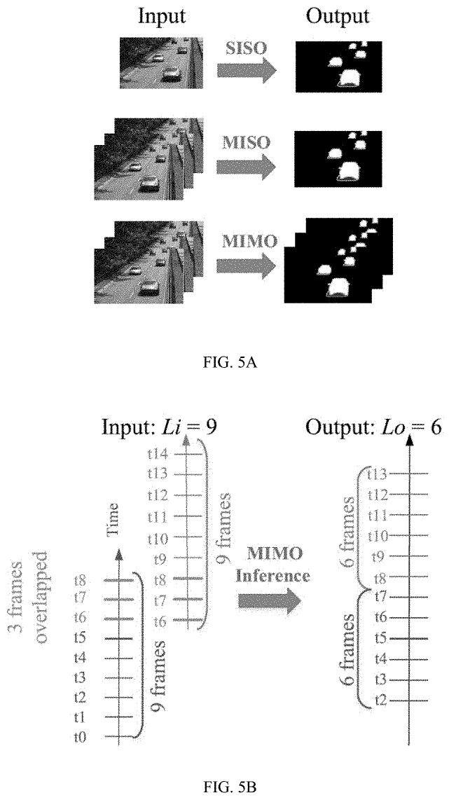

As shown in FIG. 3, the encoder network includes a first block, i.e. a first kernel as shown in FIG. 3, and five encoder blocks or kernels whose structure are the same as shown in FIG. 4A. FIG. 4A shows structure of blocks 1-5 in Table 1. The first kernel is a 3D convolution. Each of the five encoder kernels includes a 3D depth-wise convolution and a 1D point-wise convolution which follows the 3D depth-wise convolution.

The encoder network or the decoder network may include a plurality of layers, kernels or blocks as described in Table 1. These layers, kernels or blocks may be implemented by processing circuities in a kernel-based machine learning system. For example, each layer or block in the encoder network or the decoder network may be implemented by kernels such as compute unified device architecture (CUDA) kernels that can be directly run on GPUs.

As shown in FIG. 3, the decoder network includes two decoder blocks or kernels and a last kernel. The two decoder blocks or kernels are respectively block 6 and block 7 in Table 1. The last block or kernel is block 8. Each of the two decoder blocks includes a 1D point-wise transpose convolution and a 3D depth-wise transposed convolution that follows the 1D point-wise transposed convolution, as shown in FIG. 4B. FIG. 4B shows structure of blocks 6-7 in Table 1.

In the encoder network, for each training sample, the input to the encoder network is a set of video frames in a 4D shape of 9×H×W×3, where 9 is the number of video frames, H and W are the height and width of the video frames, and 3 is the RGB color channels. In FIG. 3, t₀, t₁, t₂, t₃, t₄ . . . t₈ represent different time slots. In the first step, the standard 3D convolution described in FIG. 2A is adopted with 32 filters of size 3×3×3×3 to calculate the convolution on 9 input frames. The input video frames are transformed to 32 feature maps in a shape of 9× H×W×32 at the output. In the following blocks, each of the output feature maps of each layer is convolved with an independent filter of size 3×3×3×1 with strides [1,2,2] (in the direction of temporal length, height, width) for depth-wise convolution, and then convolved with Cₒ filters of size 1×1×1×Cᵢ with strides [1, 1, 1] for pointwise convolution.

Examples of network configuration of blocks 0 to 5 in the encoder network and blocks 6 to 8 in the decoder network are shown in Table 1. As shown in Table 1, the encoder consists of blocks 0 to 5, and the decoder consists of blocks 6 to 8. The output shape is in data format “LHWC”, where L is the temporal length, H is the height, W is the width, C is the number of channels, dw represents “depth-wise convolution”, pw represents “point-wise convolution”, and s represents the strides in temporal length, height, and width.

TABLE 1

| | | Layer Type/Stride | (Filter Shape) × Number of Filters | Output Shape |
|---|---|---|---|---|
| Encoder | block 0 | | | 9 × H × W × 3 (Input) |
| | | Conv3D/s = [1, 1, 1] | (3 × 3 × 3 × 3) × 32 | 9 × H × W × 32 |
| | block 1 | Conv3D dw/s = [1, 2, 2] | (3 × 3 × 3 × 1) × 32 | $9 \times \frac{H}{2} \times \frac{W}{2} \times 32$ |
| | | Conv3D pw/s = [1, 1, 1] | (1 × 1 × 1 × 32) × 64 | $9 \times \frac{H}{2} \times \frac{W}{2} \times 64$ |
| | block 2 | Conv3D dw/s = [2, 1, 1] | (3 × 3 × 3 × 1) × 64 | $5 \times \frac{H}{2} \times \frac{W}{2} \times 64$ |
| | | Conv3D pw/s = [1, 1, 1] | (1 × 1 × 1 × 64) × 128 | $5 \times \frac{H}{2} \times \frac{W}{2} \times 128$ |
| | block 3 | Conv3D dw/s = [1, 2, 2] | (3 × 3 × 3 × 1) × 128 | $5 \times \frac{H}{4} \times \frac{W}{4} \times 128$ |
| | | Conv3D pw/s = [1, 1, 1] | (1 × 1 × 1 × 128) × 128 | $5 \times \frac{H}{4} \times \frac{W}{4} \times 128$ |
| | block 4 | Conv3D dw/s = [2, 1, 1] | (3 × 3 × 3 × 1) × 125 | $3 \times \frac{H}{4} \times \frac{W}{4} \times 128$ |
| | | Conv3D pw/s = [1, 1, 1] | (1 × 1 × 1 × 128) × 256 | $3 \times \frac{H}{4} \times \frac{W}{4} \times 256$ |
| | block 5 | Conv3D dw/s = [2, 1, 1] | (3 × 3 × 3 × 1) × 256 | $2 \times \frac{H}{4} \times \frac{W}{4} \times 256$ |
| | | Conv3D pw/s = [1, 1, 1] | (1 × 1 × 1 × 256) × 512 | $2 \times \frac{H}{4} \times \frac{W}{4} \times 512$ |
| Decoder | block 6 | Conv3DTranspose pw/s = [3, 2, 2] | (1 × 1 × 1 × 512) × 256 | $6 \times \frac{H}{2} \times \frac{W}{2} \times 256$ |
| | | Conv3D dw/s = [1, 1, 1] | (3 × 3 × 3 × 1) × 256 | $6 \times \frac{H}{2} \times \frac{W}{2} \times 256$ |
| | block 7 | Conv3DTranspose pw/s = [1, 2, 2] | (1 × 1 × 1 × 256) × 64 | 6 × H × W × 64 |
| | | Conv3D dw/s = [1, 1, 1] | (3 × 3 × 3 × 1) × 64 | 6 × H × W × 64 |
| | block 8 | Conv3DTranspose pw/s = [1, 1, 1] | (1 × 1 × 1 × 64) × 1 | 6 × H × W × 1 |
| | | Sigmoid Activation | | 6 × H × W × 1 (Output) |

In the decoder network, the output of the encoder network is fed to the decoder network for decoding to produce the binary masks of the moving objects. Each layer of the decoder network adopts a transposed convolution, which spatially upsamples the encoded features and finally generates the binary masks at the same resolution as the input video frames.

In the proposed decoder network including block 6 to block 8 in FIG. 3, the standard transposed convolution is split into a 1D pointwise transposed convolution and a 3D depth-wise transposed convolution. These operations are defined similarly to the 1D point-wise convolution and the 3D depth-wise convolution in the encoder network. In block 6 shown in Table 1, the encoder output of size

$$2 \times \frac{H}{4} \times \frac{W}{4} \times 512$$

is converted to a tensor of size

$$6 \times \frac{H}{2} \times \frac{W}{2} \times 256$$

using the 1D point-wise transposed convolution with 256 filters of size 1×1×1×512.

By setting strides to be [3, 2, 2] for the temporal length, height and width in the point-wise transposed convolution, the feature maps are up-scaled by 3 times from 2 to 6 in the temporal length and enlarged by 2 times in height and width. Then followed by a 3D depth-wise transposed convolution with 256 filters of size 3×3×3×1 and strides [1, 1, 1], the feature maps are projected to a tensor of size

$$6 \times \frac{H}{2} \times \frac{W}{2} \times 256$$

at the output of block 6. Block 7 is similarly defined. Finally in block 8, the feature maps are projected to a 4D output of size 6×H×W×1, and a sigmoid activation function is appended to generate the probability masks for 6 successive frames. A threshold of 0.5 is applied to convert the probability masks to binary masks that indicate the detected moving objects. Table 1 shows the details of the network and the shape of the input and output in each layer.

### MIMO Strategy

Normally in a standard 3D CNN, the input-output relationship is “Mto1”, representing multi-frames input to one frame output in each training sample. One disadvantage of such scheme is that it results in a slow inference speed because only one binary mask is predicted in each training sample. To remedy this problem, the present disclosure proposes a strategy that inputs multiple frames and outputs multiple binary masks for each training sample, called the MIMO strategy.

FIG. 5A illustrates the proposed MIMO strategy and how it different from SISO and MISO. The proposed MIMO strategy aims to increase the model prediction throughput by controlling the temporal dimension of the feature maps in the 3D CNN. The temporal-dimension L in the 4D input or output of size L×H×W×C is defined as the number of input frames Lᵢ and the number of output masks Lₒ. By applying different padding and stride values in the convolutions in the neural network, different number of output masks Lₒ can be predicted, and the temporal length L can be larger or smaller to output more or fewer masks temporally, in turn, to increase or decrease the inference speed, but the detection accuracy may be affected as well. It's a trade-off between the inference speed and the detection accuracy. The present disclosure empirically sets the input frames to be 9 and output frames to be 6. It is demonstrated later in the experiments that these selected parameters can achieve both faster inference speed and higher detection accuracy.

FIG. 5B illustrates the MIMO strategy used in the inference process in accordance with one example of the present disclosure. As shown in FIG. 5B, in the inference process, two groups of 9 input frames with 3 frames overlapped can output two successive groups of 6 binary masks. First, in the training process, n denotes a certain frame index in a video sequence. For each training sample, the input to the encoder is a group of 9 frames, from frame n−4 to frame n+4. The corresponding outputs of the decoder are the binary masks of 6 successive frames, from frame n−2 to frame n+3. In the inference process, as shown in FIG. 5B, two successive input “samples” are two groups of 9 frames, with 3 frames overlapped. The corresponding outputs are two groups of 6 binary masks, none overlapped. It's worth noting that the very first 2 frames and the last frame in a video stream will be missing in the output. But this issue can be ignored because the number of missing frames is small, and it only occurs at the very beginning and the end of a video stream.

Additionally, it is analyzed how computational complexity can be reduced from MISO to this MIMO scheme. According to Table 1, with the proposed MIMO scheme, the output layer in block 8 is of size L₀×H₀×W₀×(C₀=1). Since block 8 mainly requires a pointwise convolution, the multiplications required to generate such output layer is 1×1×1×Cᵢ×L₀×H₀×W₀×(C₀=1)=Cᵢ×L₀×H₀×W₀. Denote the total multiplications from block 0 to block 7 as M₀₋₇, then the overall complexity of generating Lo binary masks is M₀₋₇+Cᵢ×L₀×H₀×W₀. (11)

With the same network structure, if a MISO scheme is adopted, then the output layer is of size (L₀=1)=H₀×W₀×(C₀=1). The multiplications involved in block 8 to generate such output layer is 1×1×1×Cᵢ×(L₀=1)×H₀×W₀×(C₀=1)=Cᵢ×H₀×W₀. To generate L₀ output binary mask, the overall complexity is

(M₀₋₇+Cᵢ×H₀×W₀)×L₀=M₀₋₇×L₀+Cᵢ×L₀×H₀×W₀. (12)

Therefore, to output the same number of binary masks, MISO requires (12)-(11)=(L₀−1)×M₀₋₇ more multiplications than MIMO.

### Training and Evaluation of the MIMO Model

To analyze how the proposed MtoM 3D separable CNN performs, experiments are conducted as illustrated in Table 2: (1) video-optimized SDE setup on CDnet2014 dataset, (2) category-wise SIE setup on CDnet2014 dataset, and (3) complete-wise SIE setup on DAVIS2016 dataset. In SDE, frames in training and test sets were from the same video, whereas, in SIE, completely unseen videos were used for testing. Further, in category-wise SIE, the training and testing were done per category over CDnet2014, whereas, in complete-wise SIE, training and testing were done over the complete DAVIS2016 dataset. All the experiments were carried out on an Intel Xeon with an 8-core 3 GHz CPU and an Nvidia Titan RTX 24G GPU.

The CDnet2014 dataset was used in the experiment. It contains 11 video categories: baseline, badWeather, shadow, and so on. Each category has four to six videos, resulting in a total of 53 videos, e.g., the baseline category has sequences highway, office, pedestrians, and PETS2006). A video contains 900 to 7000 frames. The spatial resolution of the video frames varies from 240×320 to 576×720 pixels. The PTZ (pan-tilt-zoom) category is excluded in the experiment since the camera has excessive motion.

Deep learning-based methods are trained including DeepBS, MSFgNet, VGG-PSL-CRF, BSPVGAN, RMS-GAN, MSCNNCCascade, MsEDNet, FgSegNet_S, FgSegNet_M, FgSegNet_v2, 2D_Separable CNN and the proposed 3DS_MM in the same video-optimized SDE setup, in which a specific model was trained for each video.

From each video, the first 50% of frames is selected as the training set and the last 50% of frames as the test set. The SISO-based networks and the proposed MIMO-based 3DS_MM were using exactly the same frames for training. Given that one video contained 100 frames, then for the SISO-based networks, the first 50 frames t0-t49 were used for training, and the last 50 frames t50-t99 were used for testing. For the proposed 3DS_MM, a 9-frame window slid over the same first 50% of frames, such as t0-t8, t1-t9, t2-t10, . . . ,t41-t49 to form the training set if the stride was 1, and t50-t99 frames were for testing. In this way, all the deep-learning-based models were using the same frames for training. The only difference was that for the proposed MIMO network, the first 50% of frames were repeatedly utilized through the sliding operation. The traditional unsupervised methods WeSamBE, SemanticBGS, PAWCS, and SuBSENSE were also tested on the same last 50% frames for performance comparison.

RMSprop optimizer with binary cross-entropy loss function is used and each model for 30 epochs with batch size 1 is trained. The learning rate was initialized at 1×10⁻³ and was reduced by a factor of 10 if the validation loss did not decrease for 5 successive epochs.

In order to evaluate the generalization capability of the proposed 3DS_MM, experiments for the SIE setup is run as well. Compared to SDE, in SIE the training and test sets contain a completely different set of videos. In the category-wise SIE setup, the training and evaluation were conducted per category. A leave-one-video-out (LOVO) strategy may be applied to divide videos in each category into training and test sets for CDnet2014 dataset. For example, the baseline category contains four videos, then three videos (highway, office, PETS2006) were used for training, and the 4th video (pedestrians) was for testing. This SIE setup was carried out on seven categories, so for each method in comparison, seven models were trained totally from scratch.

The conventional unsupervised methods WeSamBE, PAWCS, and SuBSENSE were compared in the category-wise SIE setup. Additionally, the proposed 3DS_MM is compared with the other DNN-based networks such as BMN-BSN, BSUV-Net, BSUV-Net 2.0, and ChangeDet which were demonstrated to have great performance on unseen videos.

The RMSprop optimizer with binary cross-entropy loss function is used and the model for 30 epochs with batch size 5 is trained. The learning rate was initialized at 1×10⁻³ and was reduced by a factor of 10 if the validation loss did not decrease for 5 successive epochs.

Another experiment is conducted in complete-wise SIE setup on DAVIS2016 dataset. Different from the category-wise setup on CDnet2014, the complete-wise setup onDAVIS2016 refers to the training and evaluation on the whole dataset. In the experiment, 30 videos in DAVIS2016 dataset were used in training, and 10 completely unseen videos were used for testing. For each method in comparison, only one unified model was trained from scratch without using any pre-trained model data.

Semi-supervised deep learning-based methods such as MSK, CTN, SIAMMASK, PLM, and HEGNet, as well as FgSegNet_S, FgSeg-Net M, FgSegNet_v2, and 2D_SeparableCNN were trained and tested in the same SIE setup as the proposed 3DS_MM. The same training configuration parameters, e.g., optimizer, loss function, epochs, batch size, learning rate, etc., as those in category-wise SIE setup on CDnet2014 dataset are used.

To evaluate the efficiency of the proposed 3DS_MM model, the inference speed is measured in frames per second (fps), the model size is measured in megabytes (MB), the number of trainable parameters is measured in millions (M), and the computational complexity is measured in floating point operations (FLOPs).

To measure the detection accuracy, four metrics are adopted: the region-based F-measure, the structure measure (S-measure), the enhanced alignment measure (E-measure), and the mean absolution error (MAE). The F-measure is defined as:

$$\text{F-measure} = \frac{2 \times precision \times recall}{precision + recall} \qquad ( 13 )$$

where

$$precision = \frac{TP}{TP + FP} , recall = \frac{TP}{TP + FN} ,$$

given the true positive (TP), false positive (FP), true negative (TN), and false negative (FN).

The S-measure combines the region-aware structural similarity Sᵣ and object-aware structural similarity Sₒ, which is more sensitive to structures in scenes:

S-measure=α×Sₒ+(1−α)×Sᵣ, (14)

where α=0.5 is the balance parameter.

The E-measure is recently proposed based on cognitive vision studies and combines local pixel values with the image-level mean value in one term, jointly capturing image-level statistics and local pixel matching information.

The MAE between the predicted output and the binary ground-truth mask is also evaluated as:

$$MAE = \frac{1}{N} {\sum }_{i = 1}^{N} \vert {Pred}_{i} - {GT}_{i} \vert \qquad ( 15 )$$

where Predᵢ is the predicted value of the i-th pixel, GTᵢ is the ground-truth binary label of the i-th pixel, and N is the total number of pixels.

The influence of different components of the proposed 3DS_MM is investigated through ablation experiments. In order to quantify the effect of two components “3D separable CNN” and “MIMO” in 3DS_MM, four experiments are conducted over 10 categories of CDnet2014 dataset in SDE setup. The results are shown in Table 3. In Table 3, #Param indicates number of trainable parameters, M indicates millions, FLOPs indicate floating points operations, G indicates gigaflops, (×6) indicates six times the FLOPs in order to generate the same number of output masks as the MIMO strategy.

The experiments started with the standard 3D CNN and a MISO strategy, namely “3D CNN+MISO”. It has an F-measure of 0:9532, a very low inference speed of 26 fps, approximately 9:13 M trainable parameters, and a computational complexity of 693:31 GFLOPs, which generates 1 output binary mask. To generate 6 output masks, the GFLOPs need to be multiplied by 6 (×6). The standard 3D CNN is then replaced by the 3D separable CNN, while the MISO strategy was retained. For a fair comparison, the 3D CNN and the 3D separable CNN structures adopted the same number of network layers, and their intermediate layers have the same output sizes. The resultant “3D separable CNN+MISO” method has a slightly reduced F-measure, but the inference speed increased from 26 fps to 31 fps. More importantly, the parameters and FLOPs were drastically reduced, due to the separable convolution operations. On the other hand, the standard 3D CNN was retrained but replaced MISO by MIMO. In particular, the front part of the network is kept the same and only modify the last layer to output 6 binary masks instead of a single mask. The resultant method “3D CNN+MIMO” significantly increased the inference speed (144 fps) compared to “3D CNN+MISO”.

Moreover, the proposed “3D separable CNN+MIMO” method has a superior inference speed (154 fps) due to the MIMO strategy, as well as the fewest trainable parameters (˜0:36 M) and FLOPs (˜28:43 G) due to 3D separable convolutions. The above results have justified the effectiveness of the proposed 3DS_MM model design.

TABLE 3

| | | Inference | | |
|---|---|---|---|---|
| | Accuracy ↑ | Speed ↑ | # Param ↓ | FLOPs↓ |
| Methods | (F-measure) | (fps) | (M) | (G) |
| 3D CNN + MISO | 0.9532 | 26 | ~9.13 | ~693.31 (×6) |
| 3D separable | 0.9521 | 31 | ~0.36 | ~28.40 (×6) |
| CNN + MISO | | | | |
| 3D CNN + MIMO | 0.9522 | 144 | ~9 13 | ~693.97 |
| 3D separable | 0.9517 | 154 | ~0.36 | ~28.43 |
| CNN + MIMO | | | | |

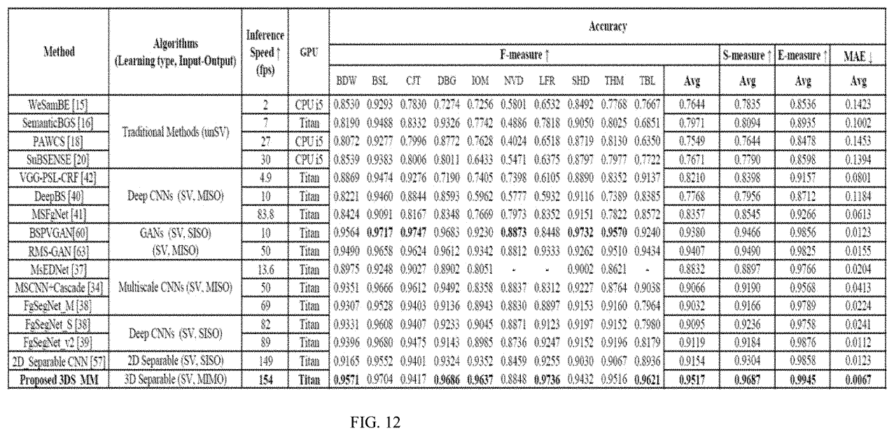

The accuracy comparison of various methods in SDE setup in each video category is shown in FIG. 12. Each row lists the inference speed, F-measure, S-measure, E-measure and MAE values for a specific method, each column lists the algorithm category, learning type (supervised or unsupervised learning), input-output relationship (SISO, MISO or MIMO), inference speed, GPU type, and F-measure values averaged on test frames from a certain video category, while the last four columns show the average F-measure, S-measure, E-measure and MAE values across all video categories. The first four classical methods are traditional non-deep learning-based methods. These traditional models are tested on the same last 50% of frames as the other compared models. In the subsequent rows, the results of deep learning-based models, including the proposed 3DS_MM model are obtained by training and testing in exactly the same SDE setup in the video-optimized SDE setup on CDnet2014 dataset. In FIG. 12, the best value in each column is highlighted in bold. Thus, the proposed 3DS_MM model achieves the highest inference speed at 154 fps, and performs best in BDW-badWeather, DBG-dynamicBackground, IOM-intermittentObjectMotion, LFR-lowFramerate, and Turbulence categories in F-measure. It improved the average F-measure by 1:1% and 1:4% compared to methods with the second and third highest average F-measure values in FIG. 12. It also offers the highest average S-measure, E-measure, and the lowest average MAE values among all methods. In FIG. 12, unSV indicates unsupervised learning, SV indicates supervised learning. ↑larger value of the metric denotes better performance. ↓Smaller value of the metric denotes better performance.

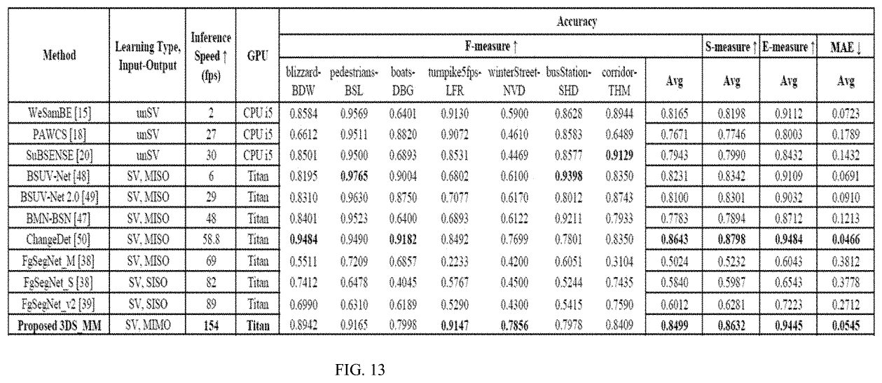

FIG. 13 lists comparative F-measure, S-measure, E-measure and MAE performance in category-wise SIE setup for unseen videos on CDnet2014 dataset. As shown in FIG. 13, unSV indicates unsupervised learning, SV indicates supervised learning, the best value in each column is highlighted in bold and the second best average accuracy values are also highlighted. ↑larger value of the metric denotes better performance. ↓Smaller value of the metric denotes better performance.

Each column lists the inference speed and accuracy metrics values calculated on the unseen video being left out from each category for testing in the LOVO strategy. The models FgSegNet_S, FgSegNet_M, FgSegNet_v2, BMN-BSN, BSUV-Net, BSUV-Net 2.0, and ChangeDet were trained and evaluated in the same SIE setup described in the category-wise SIE setup on CDnet2014 dataset as the proposed 3DS_MM model. The proposed 3DS_MM, with an inference speed at 154 fps, an F-measure of 0:8499, an S-measure of 0:8632, an E-measure of 0:9445, and an MAE of 0:0545 in some examples, outperforms all the other listed methods in inference speed, while maintaining high detection accuracy by outperforming FgSegNet_S, FgSegNet_M, FgSegNet_v2, BMN-BSN, BSUV-Net, and BSUV-Net 2.0 by 26:6%, 34:8%, 24:9%, 7:2%, 2:7%, and 3:9% in F-measure, respectively. It achieves similar superiority in terms of S-measure, E-measure and MAE as well. Although ChangeDet offers relatively better detection accuracy than the proposed 3DS_MM model, the inference speed of the proposed 3DS_MM model is 2:6 times that of ChangeDet.

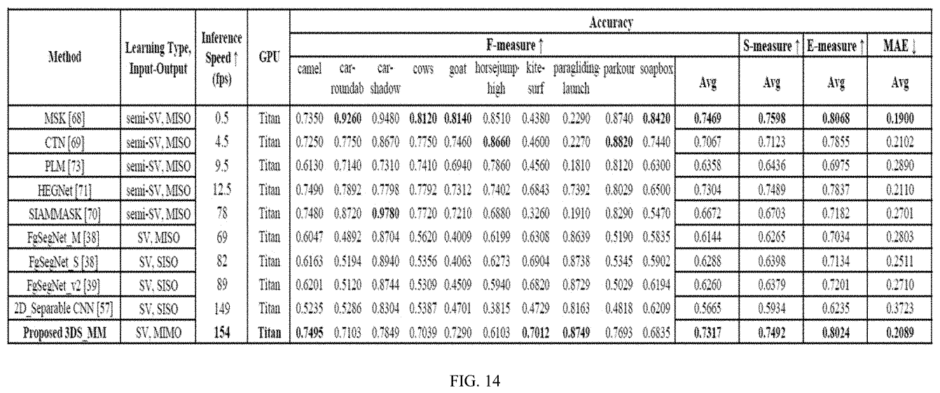

All the models listed in FIG. 14 were trained and evaluated in the same complete-wise SIE setup as described in the complete-wise SIE setup on DAVIS2016 dataset. It is more challenging for a model to perform well in such SIE setup on DAVIS2016 dataset, because (1) the complete-wise SIE setup mixes 30 different kinds of videos from the real-world together for training, and (2) the content complexity of DAVIS2016 dataset is high. The proposed model 3DS_MM, with an inference speed at 154 fps and an average F-measure of 0:7317, S-measure of 0:7492, E-measure of 0:8024 and MAE of 0:2089 over 10 test videos in some examples, is compared to the state-of-the-art semi-supervised deep learning-based models MSK, CTN, SIAMMASK, HEGNet, and PLM. Thus, the proposed 3DS_MM model is superior over these models in the inference speed. Besides, the proposed 3DS_MM model improved the F-measure by 2:5%, 9:6% and 6:5% compared to CTN, PLM and SIAMMASK, respectively, and its F-measure is on par with HEGNet. Although MSK offers 1:5% higher F-measure than the proposed 3DS_MM model, its inference speed is extremely low.

The proposed 3DS_MM model also outperforms the supervised learning-based models FgSegNet_S, FgSegNet_M, FgSegNet_v2, and 2D_Separable CNN in F-measure by 10:3%, 11:7%, 10:6%, and 16:5%, respectively. The proposed 3DS_MM model demonstrates a similar superiority in S-measure, E-measure, and MAE values. Although there are other models in DAVIS Challenge website with higher detection accuracy than the proposed model, those models are far less efficient, and their inference speed is too slow to be applied in delay-sensitive scenarios. FIG. 14 shows comparative F-measure, S-measure, E-measure and MAE performance in complete-wise SIE setup for unseen videos on DAVIS2016 dataset. In FIG. 14, semi-SV indicates semi-supervised learning, SV indicates supervised learning, the best value in each column is highlighted in bold and the second best average accuracy values are also highlighted. ↑larger value of the metric denotes better performance. ↓Smaller value of the metric denotes better performance.

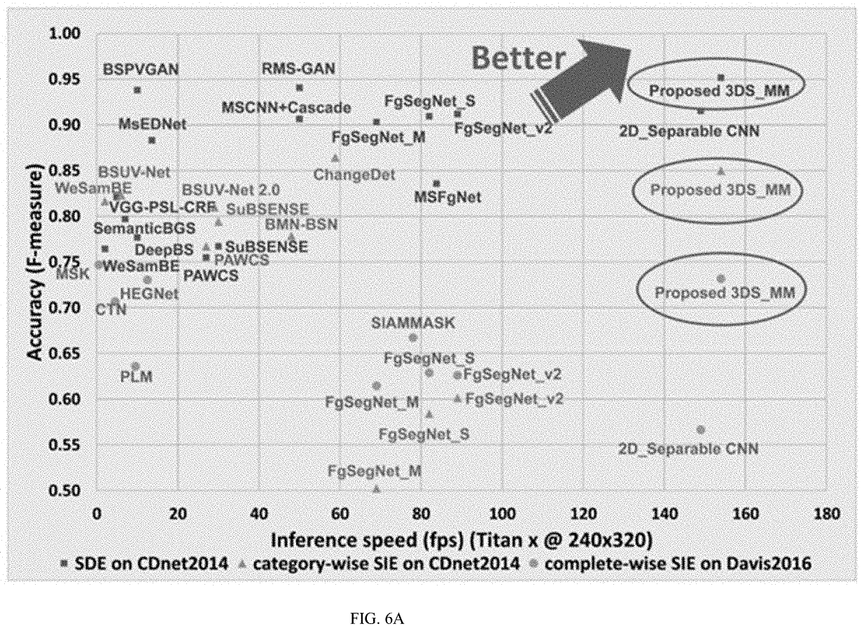

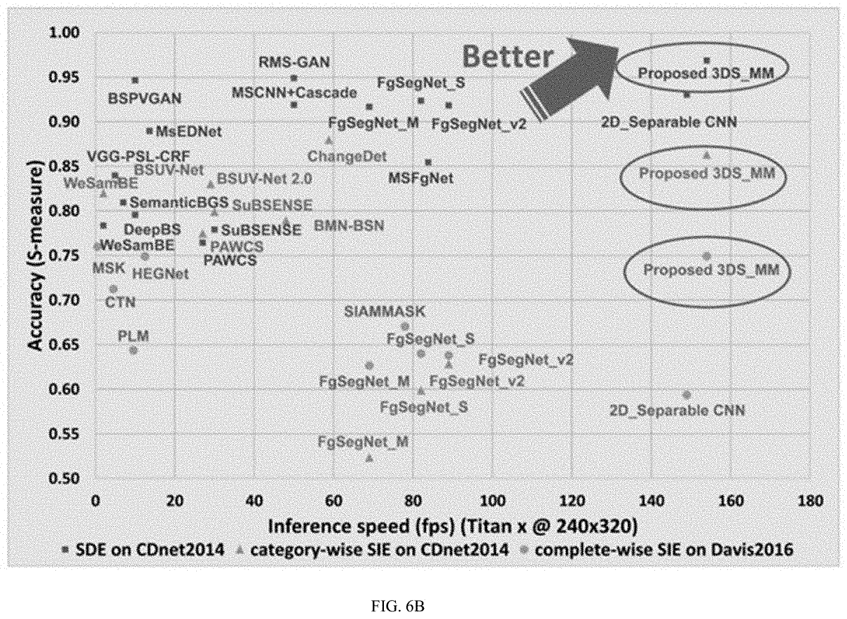

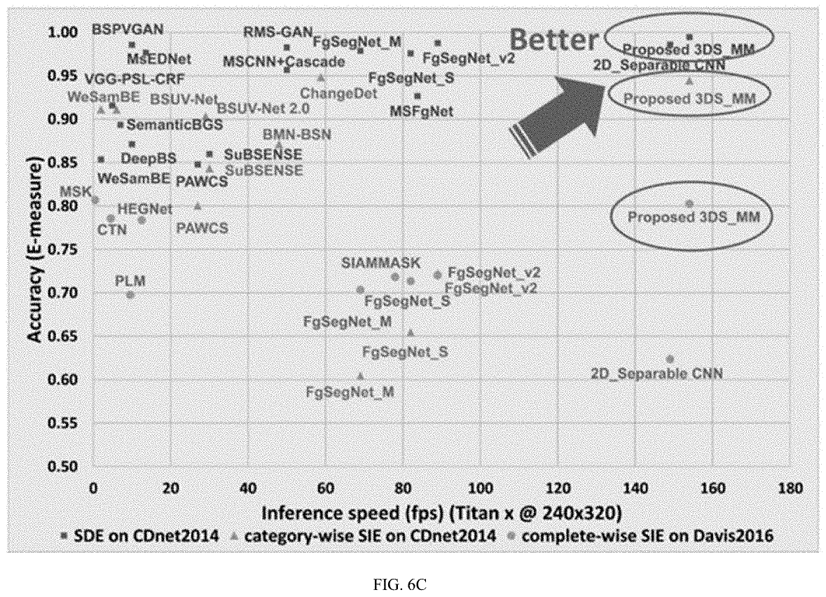

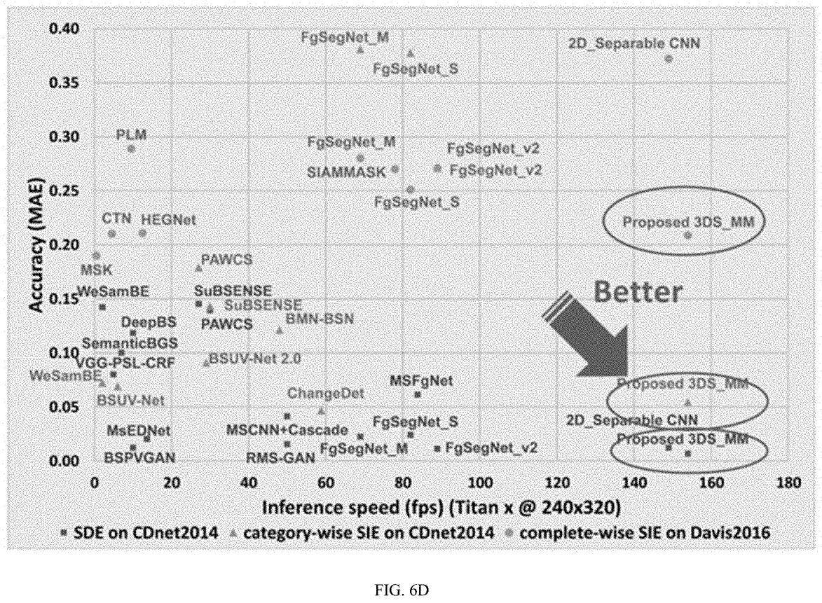

FIGS. 6A-6D displays the detection accuracy metrics in F-measure, S-measure, E-measure and MAE versus the inference speed of all the compared models in the SDE setup, category-wise SIE setup, and complete-wise SIE setup. Since it is aimed at delay-sensitive applications, it is desirable that the proposed 3DS_MM to offer overwhelmingly high inference speed, and a superior detection accuracy among models with high inference speeds. In FIGS. 5A-5D, the proposed 3DS_MM model surpasses all the other schemes in inference speed in all three experiment setups. In terms of the F-measure, S-measure, E-measure and MAE, in the SDE setup the proposed 3DS_MM is the best among all models, while in both the category-wise and complete-wise SIE setups the proposed 3DS_MM is the best among all models with an inference speed above 65 fps.

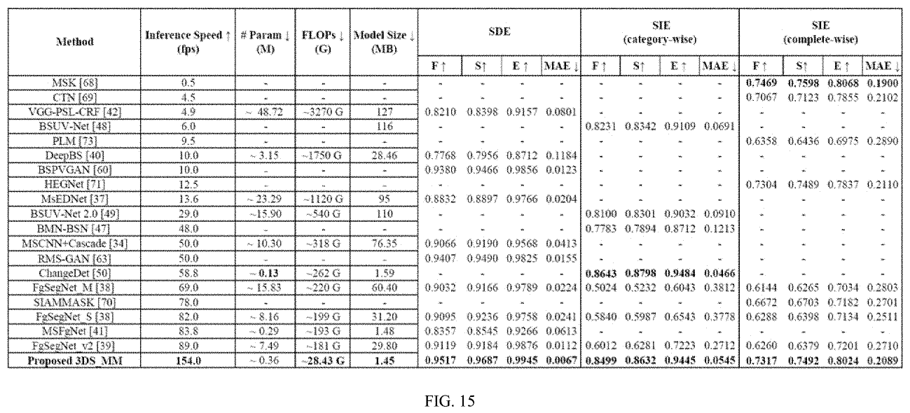

FIG. 15 summaries the overall performance including inference speed, trainable parameters, computational complexity, model size, and detection accuracy of the proposed 3DS_MM and other methods. FIG. 15 is sorted in an ascending order of the inference speed. It is evident that the proposed 3DS_MM outperforms all the other listed methods with the highest inference speed at 154 fps, which is increased by 1:7 times and 1:8 times respectively, compared to the second and third fastest methods in FIG. 15. The computational complexity and the model size of the proposed 3DS_MM model are 28:43 GFLOPs and 1:45 MB, smaller than all the other models in FIG. 15, due to the proposed 3D separable convolution.

In terms of detection accuracy (F-measure, S-measure, E-measure, and MAE), the proposed 3DS MINI method outperforms all other models in SDE setup. In category-wise SIE setup, the proposed 3DS MINI method offers the second best accuracy scores. Although it is slightly worse than changeDet, its inference speed (154 fps) is 2:6 times that of ChangeDet (58:8 fps). In complete-wise SIE setup, although the 3DS_MM model offers slightly worse accuracy scores than MSK, it offers overwhelming superiority in terms of inference speed. The extremely low inference speed of MSK (0:5 fps) hinders the practical use of this model for delay-sensitive applications.

The number of trainable parameters of the proposed 3DS_MM model (˜0:36 million) is much less than most of the models in comparison. The reason that ChangeDet (˜0:13 million) and MSFgNet (˜0:29 million) have fewer trainable parameters than the proposed 3DS_MM network is because they use 2D filters and they are shallower networks with fewer convolutional layers, while the proposed 3DS_MM network uses 3D filter and a deeper network. Nevertheless, the inference speeds of ChangeDet and MSFgNet are much slower than the proposed 3DS MINI network since they are both MISO networks. In contrast, the proposed 3DS MINI is able to significantly increase the inference speed due to the proposed MIMO strategy and 3D separable convolution.

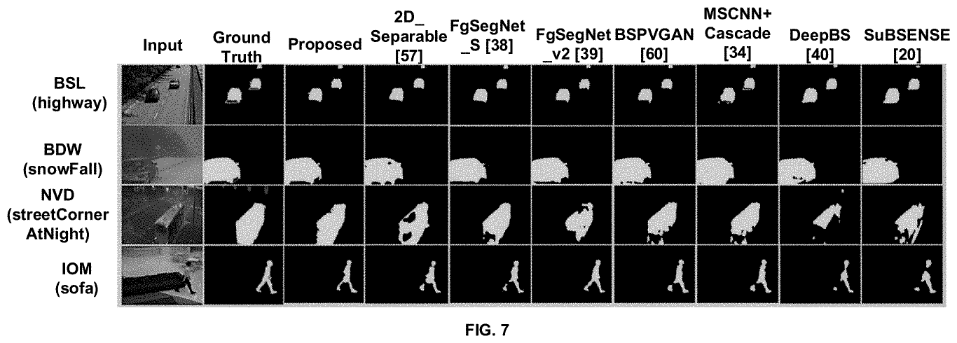

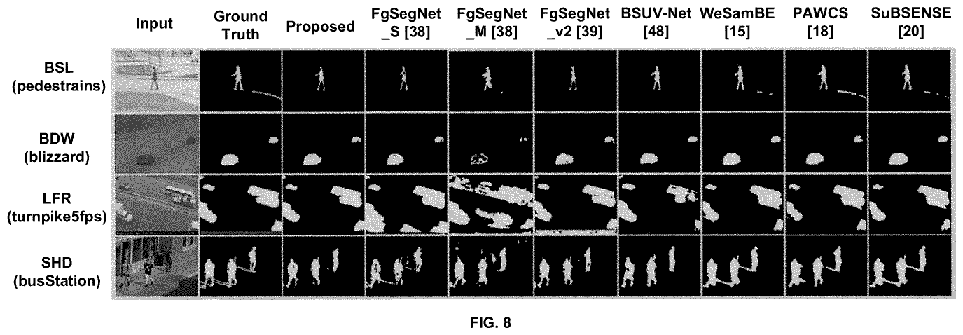

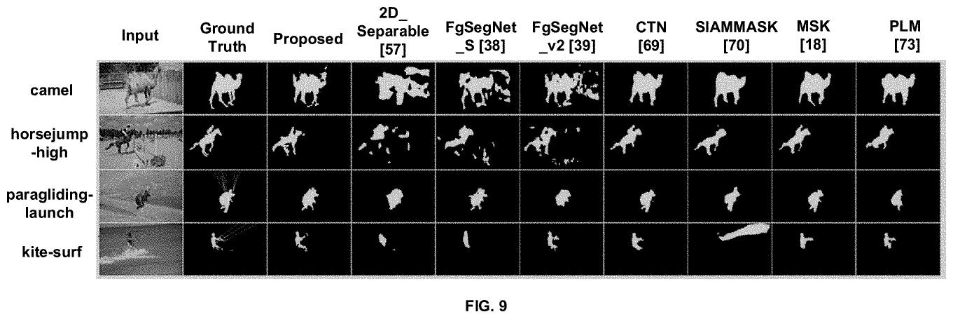

In addition to objective performance, visual quality comparison is also provided as shown in FIGS. 7-9. FIG. 7 illustrates visual comparison of sample results from CDnet2014 dataset in video-optimized SDE setup. As shown in FIG. 7, BSL denotes baseline, BDW denotes badWeather, NVD denotes nightVideo, and IOM denotes intermittentObjectMotion. In FIG. 7, a sample test frame is randomly picked from categories BSL-baseline, BDW-badWeather, NVD-nightVideos, and IOM-intermittentObjectMotion. It is observed that (1) the proposed 3DS_MM provides more details and clearer edges in the detected foreground objects, such as the car mirrors in “BSL” and “BDW”, and (2) the proposed method detects more contiguous objects such as the bus in “NVD” and the walking man in “IOM”. In contrast, the detected binary masks of other methods in comparison have either blurry edges or missing parts.

FIG. 8 illustrates visual comparison of unseen sample results from CDnet2014 dataset in category-wise SIE setup. As shown in FIG. 8, BSL denotes baseline, BDW denotes badWeather, LFR denotes lowFramerate, SHD denotes shadow. In FIG. 8, a sample frame is randomly selected from each of the four categories (BSL-baseline, BDW-badWeather, LFRlowFramerate, SHD-shadow) of CDnet2014 test results to show the visual quality of the models in Category-Wise SIE setup. The proposed 3DS_MM model has a better generalization capability compared to other models. It shows that the proposed 3DS_MM model detects clearer shapes of the persons in BSL and SHD, and detects more details of person legs in SHD. The results of other methods, however, are either noisy, blurry, or have missing parts. In addition, the proposed model performs better in BDWand LFR categories with clear and correct shapes, while other models detect excessive or non-contiguous content.

In FIG. 9, four videos including camel, horsejumphigh, paragliding-launch, and kite-surf are randomly selected from the results of DAVIS2016. The proposed 3DS_MM model detects the shapes of objects consistently well for all four videos, while the detection results of 2D_Separable, FgSegNet_S, FgSeg-Net_v2, and SIAMMASK are either noisy or incomplete. Besides, the detection results of CTN, MSK, and PLM for the kite-surf video are less accurate than the proposed 3DS_MM model.

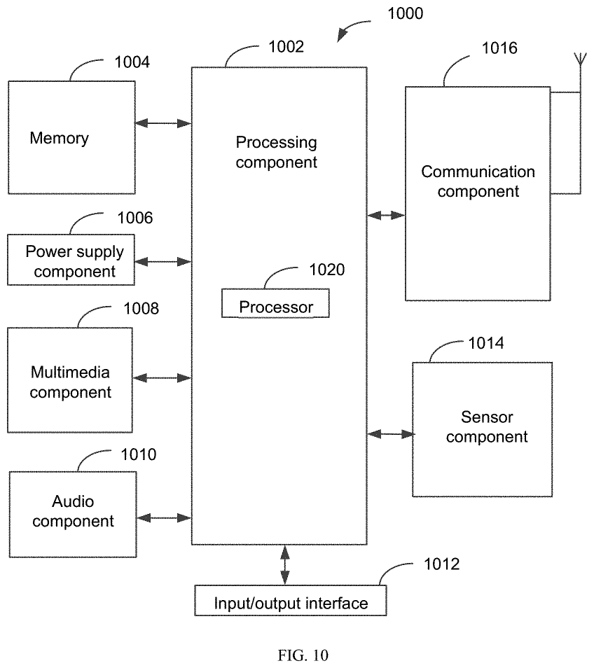

FIG. 10 is a block diagram illustrating an apparatus for AMPR in accordance with some implementations of the present disclosure. The apparatus 1000 may be a terminal, such as a mobile phone, a tablet computer, a digital broadcast terminal, a tablet device, or a personal digital assistant.

As shown in FIG. 10, the apparatus 1000 may include one or more of the following components: a processing component 1002, a memory 1004, a power supply component 1006, a multimedia component 1008, an audio component 1010, an input/output (I/O) interface 1012, a sensor component 1014, and a communication component 1016.

The processing component 1002 usually controls overall operations of the apparatus 1000, such as operations relating to display, a telephone call, data communication, a camera operation, and a recording operation. The processing component 1002 may include one or more processors 1020 for executing instructions to complete all or a part of steps of the above method. Further, the processing component 1002 may include one or more modules to facilitate interaction between the processing component 1002 and other components. For example, the processing component 1002 may include a multimedia module to facilitate the interaction between the multimedia component 1008 and the processing component 1002.

The memory 1004 is configured to store different types of data to support operations of the apparatus 1000. Examples of such data include instructions, contact data, phonebook data, messages, pictures, videos, and so on for any application or method that operates on the apparatus 1000. The memory 1004 may be implemented by any type of volatile or non-volatile storage devices or a combination thereof, and the memory 1004 may be a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or a compact disk.

The power supply component 1006 supplies power for different components of the apparatus 1000. The power supply component 1006 may include a power supply management system, one or more power supplies, and other components associated with generating, managing and distributing power for the apparatus 1000.

The multimedia component 1008 includes a screen providing an output interface between the apparatus 1000 and a user. In some examples, the screen may include a Liquid Crystal Display (LCD) and a Touch Panel (TP). If the screen includes a touch panel, the screen may be implemented as a touch screen receiving an input signal from a user. The touch panel may include one or more touch sensors for sensing a touch, a slide and a gesture on the touch panel. The touch sensor may not only sense a boundary of a touching or sliding actions, but also detect duration and pressure related to the touching or sliding operation. In some examples, the multimedia component 1008 may include a front camera and/or a rear camera. When the apparatus 1000 is in an operation mode, such as a shooting mode or a video mode, the front camera and/or the rear camera may receive external multimedia data.

The audio component 1010 is configured to output and/or input an audio signal. For example, the audio component 1010 includes a microphone (MIC). When the apparatus 1000 is in an operating mode, such as a call mode, a recording mode and a voice recognition mode, the microphone is configured to receive an external audio signal. The received audio signal may be further stored in the memory 1004 or sent via the communication component 1016. In some examples, the audio component 1010 further includes a speaker for outputting an audio signal.

The I/O interface 1012 provides an interface between the processing component 1002 and a peripheral interface module. The above peripheral interface module may be a keyboard, a click wheel, a button, or the like. These buttons may include but not limited to, a home button, a volume button, a start button, and a lock button.

The sensor component 1014 includes one or more sensors for providing a state assessment in different aspects for the apparatus 1000. For example, the sensor component 1014 may detect an on/off state of the apparatus 1000 and relative locations of components. For example, the components are a display and a keypad of the apparatus 1000. The sensor component 1014 may also detect a position change of the apparatus 1000 or a component of the apparatus 1000, presence or absence of a contact of a user on the apparatus 1000, an orientation or acceleration/deceleration of the apparatus 1000, and a temperature change of apparatus 1000. The sensor component 1014 may include a proximity sensor configured to detect presence of a nearby object without any physical touch. The sensor component 1014 may further include an optical sensor, such as a CMOS or CCD image sensor used in an imaging application. In some examples, the sensor component 1014 may further include an acceleration sensor, a gyroscope sensor, a magnetic sensor, a pressure sensor, or a temperature sensor.

The communication component 1016 is configured to facilitate wired or wireless communication between the apparatus 1000 and other devices. The apparatus 1000 may access a wireless network based on a communication standard, such as WiFi, 4G, or a combination thereof. In an example, the communication component 1016 receives a broadcast signal or broadcast related information from an external broadcast management system via a broadcast channel. In an example, the communication component 1016 may further include a Near Field Communication (NFC) module for promoting short-range communication. For example, the NFC module may be implemented based on Radio Frequency Identification (RFID) technology, infrared data association (IrDA) technology, Ultra-Wide Band (UWB) technology, Bluetooth (BT) technology and other technology.

In an example, the apparatus 1000 may be implemented by one or more of Application Specific Integrated Circuits (ASIC), Digital Signal Processors (DSP), Digital Signal Processing Devices (DSPD), Programmable Logic Devices (PLD), Field Programmable Gate Arrays (FPGA), controllers, microcontrollers, microprocessors, or other electronic elements to perform the above method.

A non-transitory computer readable storage medium may be, for example, a Hard Disk Drive (HDD), a Solid-State Drive (SSD), Flash memory, a Hybrid Drive or Solid-State Hybrid Drive (SSHD), a Read-Only Memory (ROM), a Compact Disc Read-Only Memory (CD-ROM), a magnetic tape, a floppy disk, etc.

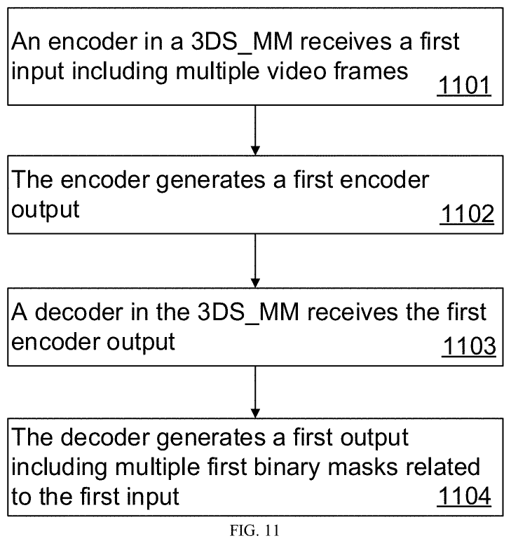

FIG. 11 is a flowchart illustrating a process for detecting moving objects in video frames in accordance with some implementations of the present disclosure.

In step 1101, an encoder in the 3DS_MM receives a first input including multiple video frames. The encoder may be the encoder network as shown in FIG. 3.

In some examples, the encoder may include a plurality of encoder layers including 3D separable CNN layers. For example, the plurality of encoder layers may be the blocks 0-5 as shown in Table 1.

In some examples, the plurality of encoder layers may include a first encoder layer and one or more second encoder layers following the first encoder layer. Further, each of the one or more second encoder layers may include a 3D depth-wise CNN layer and a 1D point-wise CNN layer following the 3D depth-wise CNN layer. For example, the first encoder layer may be block 0 in Table 1 and the one or more second encoder layers may be blocks 1-5 in Table 1.

In some examples, the multiple video frames may be in a 4D shape of Lᵢ×H₁×W₁×C, Lᵢ is a number of the multiple video frames, H₁ and W₁ may be respectively a height and a width of the multiple video frames, and C is a number of channels of the first input.

In step 1102, the encoder generates a first encoder output. For example, the first encoder output may be the output of block 0 in Table 1.

In step 1103, a decoder in the 3DS MINI receives the first encoder output. For example, the decoder may be the decoder network shown in FIG. 3.

In step 1104, the decoder generates a first output including multiple first binary masks related to the first input. For example, the first output may be the output shown in FIG. 3.

In some examples, the decoder may include a plurality of decoder layers including 3D separable transposed CNN layers.

In some examples, each of the plurality of decoder layers may include a 1D point-wise transposed CNN layer and a 3D depth-wise transposed CNN layer following the 1D point-wise transposed CNN layer. For example, the plurality of decoder layers may include blocks 6-7 in Table 1.

In some examples, the first output may be in a 4D shape of L₀×H₂×W₂×1, wherein Lₒ is a number of frames in the first output, H₂ and W₂ may be respectively a height and a width of the multiple first binary masks.

In some examples, H₁ may be the same as H₂, and W₁ may be the same as W₂, and Li may be greater than Lₒ.

In some examples, the multiple first binary masks may indicate moving objects detected in the multiple video frames in the first input.

In some examples, the encoder may receive a second input including a same number of video frames as the first input and generate a second encoder output. The first input and the second input are successive relative to time. The decoder may receive the second encoder output and generate a second output including multiple second binary masks.

Further, the multiple video frames in the first input may include successive frames relative to time, the video frames in the second input may include successive frames relative to time, and the multiple video frames in the first input overlap with the video frames in the second input relative to time. Moreover, the multiple first binary masks in the first output may include successive frames relative to time, the multiple second binary masks in the second output may include successive frames relative to time, and the multiple first binary masks do not overlap with the multiple second binary masks relative to time.

In some examples, a number of the plurality of encoder layers may be greater than a number of the plurality of decoder layers.

In some examples, there is provided an apparatus for detecting moving objects in video frames. The apparatus includes one or more processors 1020 and a memory 1004 configured to store instructions executable by the one or more processors; where the processor, upon execution of the instructions, is configured to perform the method as described in FIG. 11.

In some other examples, there is provided a non-transitory computer readable storage medium 1004, having instructions stored therein. When the instructions are executed by one or more processors 1020, the instructions cause the processor to perform the method as described in FIG. 11.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

The examples were chosen and described in order to explain the principles of the disclosure, and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for detecting moving objects in video frames, comprising:
receiving, by an encoder in a 3-dimenional (3D) separable convolutional neural network with multi-input multi-output (3DS_MM), a first input comprising multiple video frames, wherein the encoder comprises a plurality of encoder layers comprising 3D separable convolutional neural network (CNN) layers;
generating, by the encoder, a first encoder output; and
receiving, by a decoder in the 3DS_MM, the first encoder output and generating, by the decoder, a first output comprising multiple first binary masks related to the first input, wherein the decoder comprises a plurality of decoder layers comprising 3D separable transposed CNN layers.

2. The method of claim 1, wherein the plurality of encoder layers comprise a first encoder layer and one or more second encoder layers following the first encoder layer, each of the one or more second encoder layers comprises a 3D depth-wise CNN layer and a 1-dimensional (1D) point-wise CNN layer following the 3D depth-wise CNN layer.

3. The method of claim 2, wherein each of the plurality of decoder layers comprises a 1D point-wise transposed CNN layer and a 3D depth-wise transposed CNN layer following the 1D point-wise transposed CNN layer.

4. The method of claim 1, wherein the multiple video frames are in a 4-dimensional (4D) shape of Lᵢ×H₁×W₁×C, Lis a number of the multiple video frames, H₁ and W₁ are respectively a height and a width of the multiple video frames, and C is a number of channels of the first input.

5. The method of claim 4, wherein the first output is in a 4D shape of L₀×H₂×W₂×1, wherein Lₒ is a number of frames in the first output, H₂ and W₂ are respectively a height and a width of the multiple first binary masks.

6. The method of claim 5, wherein H₁ is the same as H₂, and W₁ is the same as W₂, and Li is greater than L₀.

7. The method of claim 1, wherein the multiple first binary masks indicate moving objects detected in the multiple video frames in the first input.

8. The method of claim 1, further comprising:
receiving, by the encoder, a second input comprising a same number of video frames as the first input and generating, by the encoder, a second encoder output, wherein the first input and the second input are successive relative to time; and
receiving, by the decoder, the second encoder output and generating, by the decoder, a second output comprising multiple second binary masks,
wherein the multiple video frames in the first input comprise successive frames relative to time, the video frames in the second input comprise successive frames relative to time, and the multiple video frames in the first input overlap with the video frames in the second input relative to time,
wherein the multiple first binary masks in the first output comprise successive frames relative to time, the multiple second binary masks in the second output comprise successive frames relative to time, and the multiple first binary masks do not overlap with the multiple second binary masks relative to time.

9. The method of claim 1, wherein a number of the plurality of encoder layers are greater than a number of the plurality of decoder layers.

10. An apparatus for detecting moving objects in video frames, comprising:
one or more processors; and
a memory configured to store instructions executable by the one or more processors,
wherein the one or more processors, upon execution of the instructions, are configured to:
receive, by an encoder in 3-dimenional (3D) separable convolutional neural network with multi-input multi-output (3DS_MM), a first input comprising multiple video frames, wherein the encoder comprises a plurality of encoder layers comprising 3D separable convolutional neural network (CNN) layers;
generate, by the encoder, a first encoder output; and
receive, by a decoder in the 3DS_MM, the first encoder output and generate, by the decoder, a first output comprising multiple first binary masks related to the first input, wherein the decoder comprises a plurality of decoder layers comprising 3D separable transposed CNN layers.

11. The apparatus of claim 10, wherein the plurality of encoder layers comprise a first encoder layer and one or more second encoder layers following the first encoder layer, each of the one or more second encoder layers comprises a 3D depth-wise CNN layer and a 1-dimensional (1D) point-wise CNN layer following the 3D depth-wise CNN layer.

12. The apparatus of claim 11, wherein each of the plurality of decoder layers comprises a 1D point-wise transposed CNN layer and a 3D depth-wise transposed CNN layer following the 1D point-wise transposed CNN layer.

13. The apparatus of claim 10, wherein the multiple video frames are in a 4-dimensional (4D) shape of Lᵢ×H₁×W₁×C, Lᵢ is a number of the multiple video frames, H₁ and W₁ are respectively a height and a width of the multiple video frames, and C is a number of channels of the first input.

14. The apparatus of claim 13, wherein the first output is in a 4D shape of L₀×H₂×W₂×1, wherein Lₒ is a number of frames in the first output, H₂ and W₂ are respectively a height and a width of the multiple first binary masks.

15. The apparatus of claim 14, wherein H₁ is the same as H₂, and W₁ is the same as W₂, and Lᵢ is greater than L₀.

16. The apparatus of claim 10, wherein the multiple first binary masks indicate moving objects detected in the multiple video frames in the first input.

17. The apparatus of claim 10, wherein the one or more processors are further configured to:
receive, by the encoder, a second input comprising a same number of video frames as the first input and generate, by the encoder, a second encoder output, wherein the first input and the second input are successive relative to time; and
receive, by the decoder, the second encoder output and generate, by the decoder, a second output comprising multiple second binary masks,
wherein the multiple video frames in the first input comprise successive frames relative to time, the video frames in the second input comprise successive frames relative to time, and the multiple video frames in the first input overlap with the video frames in the second input relative to time,
wherein the multiple first binary masks in the first output comprise successive frames relative to time, the multiple second binary masks in the second output comprise successive frames relative to time, and the multiple first binary masks do not overlap with the multiple second binary masks relative to time.

18. The apparatus of claim 10, wherein a number of the plurality of encoder layers are greater than a number of the plurality of decoder layers.

19. A non-transitory computer-readable storage medium for detecting moving objects in video frames storing computer-executable instructions that, when executed by one or more computer processors, causing the one or more computer processors to perform acts comprising:
receiving, by an encoder in 3-dimenional (3D) separable convolutional neural network with multi-input multi-output (3DS MIN), a first input comprising multiple video frames, wherein the encoder comprises a plurality of encoder layers comprising 3D separable convolutional neural network (CNN) layers;
generating, by the encoder, a first encoder output; and
receiving, by a decoder in the 3DS MINI, the first encoder output and generating, by the decoder, a first output comprising multiple first binary masks related to the first input, wherein the decoder comprises a plurality of decoder layers comprising 3D separable transposed CNN layers.

20. The non-transitory computer-readable storage medium of claim 19, wherein the plurality of encoder layers comprise a first encoder layer and one or more second encoder layers following the first encoder layer, each of the one or more second encoder layers comprises a 3D depth-wise CNN layer and a 1-dimensional (1D) point-wise CNN layer following the 3D depth-wise CNN layer, and
wherein each of the plurality of decoder layers comprises a 1D point-wise transposed CNN layer and a 3D depth-wise transposed CNN layer following the 1D point-wise transposed CNN layer.
